(19) United States
(12) Patent Application Publication
(10) Pub. No.: US 2005/0010427 A1
(43) Pub. Date: Jan. 13, 2005

(54) Partner management

(75) Inventors: Aditya Bhandarkar, Redmond, WA (US); David Fong, Kirkland, WA (US); Eddie Fusaro, Redmond, WA (US); Mayank Mehta, Bellevue, WA (US); Anand C. Ramanathan, Bellevue, WA (US); Dharma Shukla, Sammamish, WA (US); Kumarswamy Valegerepura, Bellevue, WA (US); Mark Nathan Wain, Seattle, WA (US); Muralidhara Varma Chilayurl, Sammamish, WA (US)

Correspondence Address: BANNER & WITCOFF LTD.,;ATTORNEYS FOR MICROSOFT, 1001 G STREET , N.W., ELEVENTH STREET, WASHINGTON, DC, 20001-4597, US

(73) Assignee: Microsoft Corporation, Redmond, WA (US)

(21) Appl. No.: 10/617,904

(22) Filed: Jul. 11, 2003

(51) Int. Cl. G06F 17/60

(52) U.S. Cl. 705/1; 705/10

(57) ABSTRACT

Partner management systems and methods are disclosed. A designer designs a business process that provides selection criteria for selecting business partners. The business process is compiled and executed by a business process execution engine. During the execution of the business process, the business process execution engine uses the selection criteria to select business partners. The identification of business partners and attributes of the business partners may be modified without modifying the business process.

### FIELD OF THE INVENTION

Aspects of the present invention relate to computer implemented business processes. More specifically, aspects of the present invention relate to computer implemented business processes that allow users to manage partners and to dynamically select partners.

### BACKGROUND

Computer implemented business process applications are used to automate business processes. For example, a supply order business process application may receive a request for a supply from an employee and transmit an order for the supply to a supply partner. Conventional computer implemented business process applications require a user to program the partner information directly into the business process application. In this example, the identification of the business partner and certain attributes, such as address and contact information, are included or hard coded directly into the business process application.

Among other disadvantages, coding partner information directly into a business process application results in a requirement that the business process application be modified and recompiled when business partners or business partner attributes change. This requirement becomes more burdensome as the number of partners increase and can be a factor in limiting the number of attributes to assign to a partner. With existing applications it is impractical to include numerous attributes that frequently change.

Therefore, there is a need in the art for business process methods and systems that allow an end user to manage partner information without modifying and/or recompiling the business process application.

### BRIEF SUMMARY

Aspects of the present invention address one or more of the issues mentioned above, thereby providing a computer implemented business process system that allows users to dynamically manage business partners without modifying the business process. A business process identifies selection criteria for selecting business partners. Business partners can be added, modified and deleted without changing the business process.

### BRIEF DESCRIPTION OF THE DRAWINGS

Aspects of the present invention are described with respect to the accompanying figures, in which like reference numerals identify like elements, and in which:

FIG. 1 illustrates an example of a suitable distributed computing system operating environment in which the invention may be implemented;

FIG. 2 illustrates a computer implemented system for executing a business process in accordance with an embodiment of the invention;

FIG. 3 illustrates an implementation for ordering supplies in accordance with an embodiment of the invention;

FIG. 4 illustrates an embodiment in which a user interface is used to update supply partner attributes, in accordance with an embodiment of the invention;

FIG. 5 illustrates a user interface that allows a user to manage supplier partners, in accordance with an embodiment of the invention.

FIG. 6 illustrates a nested business process embodiment, in accordance with an embodiment of the invention.

### DETAILED DESCRIPTION

Exemplary Operating Environment

Aspects of the present invention may be implemented with a distributed computer system operating environment that provides an instant messaging capability. In a distributed computing environment, tasks may be performed by remote computer devices that are linked through communications networks. The distributed computing environment may include client and server devices that may communicate either locally or via one or more computer networks. Embodiments of the present invention may comprise special purpose and/or general purpose computer devices that each may include standard computer hardware such as a central processing unit (CPU) or other processing means for executing computer executable instructions, computer readable media for storing executable instructions, a display or other output means for displaying or outputting information, a keyboard or other input means for inputting information, and so forth. Examples of suitable computer devices include hand-held devices, multiprocessor systems, microprocessor-based or programmable consumer electronics, networked PCs, minicomputers, mainframe computers, and the like.

The invention will be described in the general context of computer-executable instructions, such as program modules, that are executed by a processing device, including, but not limited to a personal computer. Generally, program modules include routines, programs, objects, components, data structure definitions and instances, etc., that perform particular tasks or implement particular abstract data types. Typically the functionality of the program modules may be combined or distributed as desired in various environments.

Embodiments within the scope of the present invention also include computer readable media having executable instructions. Such computer readable media can be any available media that can be accessed by a general purpose or special purpose computer. By way of example, and not limitation, such computer readable media can comprise RAM, ROM, EEPROM, CD-ROM or other optical disk storage, magnetic disk storage or other magnetic storage devices, or any other medium which can be used to store the desired executable instructions and which can be accessed by a general purpose or special purpose computer. Combinations of the above should also be included within the scope of computer readable media. Executable instructions comprise, for example, instructions and data which cause a general purpose computer, special purpose computer, or special purpose processing device to perform a certain function or group of functions.

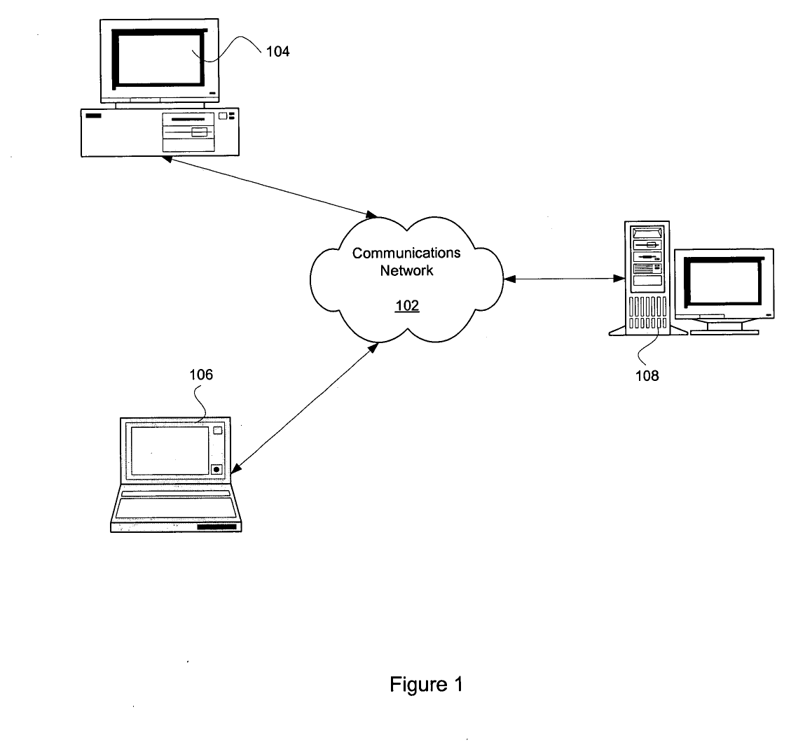

FIG. 1 illustrates an example of a suitable distributed computing system 100 operating environment in which the invention may be implemented. Distributed computing system 100 is only one example of a suitable operating environment and is not intended to suggest any limitation as to the scope of use or functionality of the invention. System 100 is shown as including a communications network 102. The specific network implementation used can be comprised of, for example, any type of local area network (LAN) and associated LAN topologies and protocols; simple point-to-point networks (such as direct modem-to-modem connection); and wide area network (WAN) implementations, including public Internets and commercial based network services such as the Microsoft Network or America Online's Network. Systems may also include more than one communication network, such as a LAN coupled to a network.

Computer device 104, computer device 106 and computer device 108 may be coupled to communications network 102 through communication devices. Network interfaces or adapters may be used to connect computer devices 104, 106 and 108 to a LAN. When communications network 102 includes a WAN, modems or other means for establishing communications over WANs may be utilized. Computer devices 104, 106 and 108 may communicate with one another via communication network 102 in ways that are well known in the art. The existence of any of various well-known protocols, such as TCP/IP, Ethernet, FTP, HTTP and the like, is presumed. Computer devices 104, 106 and 108 may exchange content, applications, messages and other objects via communications network 102.

Description of Illustrative Embodiments

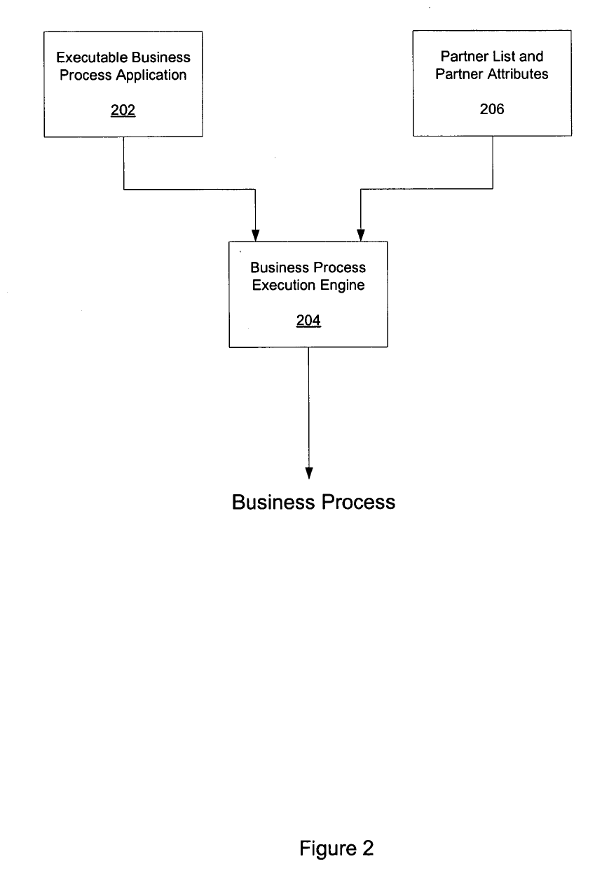

FIG. 2 illustrates a computer implemented system for executing a business process in accordance with an embodiment of the invention. An executable business process application 202 is sent to a business process execution engine 204. Executable business process application 202 may be in the form of assembly code and include selection criteria for selecting business partners. A list of business partners and partner attributes 206 is also sent to business process execution engine 202. Business process execution engine 204 executes the business process defined in executable business process application 202. In one embodiment, business process execution engine is implemented with an XLANG Scheduler Engine. Business process execution engine 204 also uses the selection criteria included in executable business process application 202 to select business partners. The selection of business partners is described in detail below.

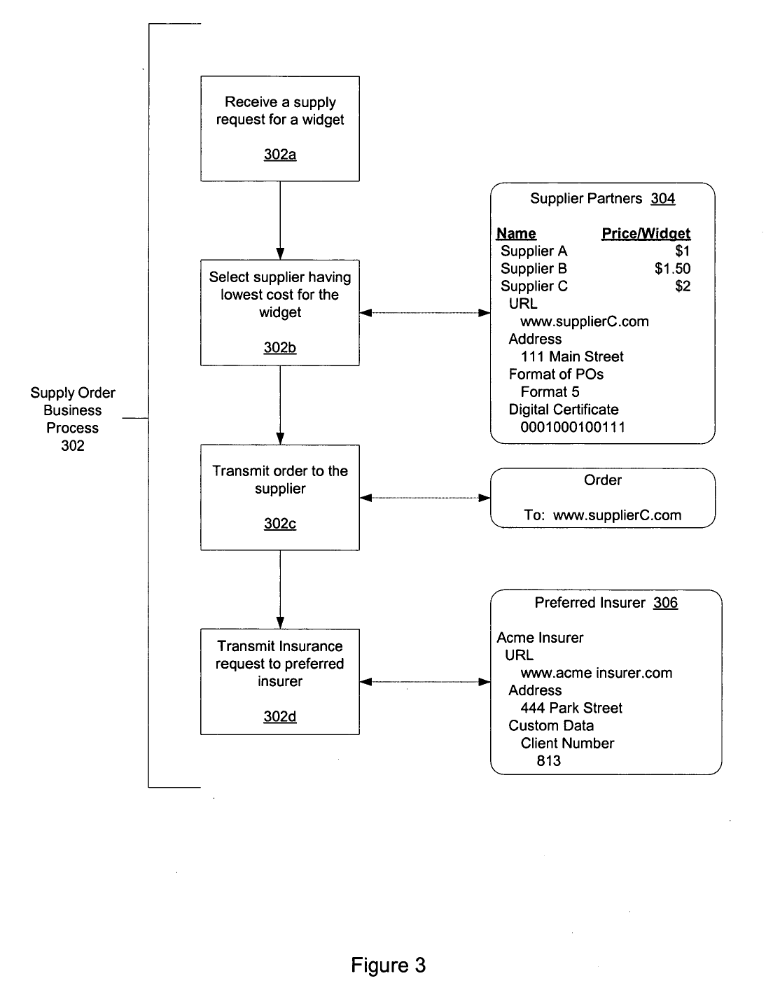

FIG. 3 illustrates an implementation for ordering supplies in accordance with an embodiment of the invention. A supply order business process 302 includes a series of defined steps. Business process 302 may be created with a visual design tool, such as Orchestration Designer. In step 302a a supply request for a widget is received. Step 302a may include receiving the request from a predetermined port using a defined format. Step 302b includes selecting a supplier having the lowest cost for the widget. The suppliers are business partners of the entity utilizing supply order business process 302. Step 302b provides a selection criteria for selecting a business partner. In a particular, step 302b instructs a business process execution engine to select the partner having the lowest cost for the widget. Defining partners in terms of selection criteria allows for the management of partnership attributes without modifying and/or recompiling the business process. For example, URLs, addresses, prices, digital certificates, etc. can be modified without modifying and/or recompiling the business process.

A business process execution engine may access one or more databases when selecting business partners. The implementation shown in FIG. 3 includes a database of supply partners 304. Supplier A sells widgets for $1, Supplier B sells widgets for $1.50 and Supplier C sells widgets for $2. The selection criteria provided in step 302b would result in the selection of Supplier A.

Suppliers A-C and or the entity utilizing supply order business process 302 may change the partnership attributes shown in supply partners database 304. For example, Supplier C could set the widget price at $0.50. The next time supply order business process 302 is executed, Supplier C would be selected. A variety of attributes may be included in a database of business partners. The types of attributes may be a function of the role of the partner. The attributes listed for Supplier C include a URL, an address, a preferred format for purchase orders and a digital certificate. In one embodiment of the invention, preferred formats are identified by extensible markup language (XML) schemas. Of course suppliers A and B may also included similar and/or additional attributes. Moreover, some business partners may include custom data that is not used by a business process.

Once a partner is selected, a variable may then be bound to use the identified partner in subsequent instances of the variable. For example, in step 302c an order is transmitted to the supplier. The supplier in step 302c would correspond to the supplier selected in step 302b. Step 302c would include transmitting an order to an address attribute included in supply partners database 304 for Supplier A.

There are numerous ways to describe selection criteria for selecting a business partner. Quotas, ratios, orders, formulas, etc. may be used. In some embodiments, the selection criteria is not known by some or any of the business partners. Moreover, an entity may specify preferred business partners. For example, in step 302d an insurance request is transmitted to a preferred insurer. The preferred insurer and attributes of the preferred insurer are listed in preferred insurer database 306. The preferred insurer and/or attributes of the preferred insurer may be changed without modifying business process 302.

One skilled in the art will appreciate that supply order business process 302 is merely one example of a business process that may use aspects of the invention. Moreover, as used herein “business process” is not limited to processes that include the exchange of money. Other business processes may include the exchange of information. Businesses processes may also take place between enterprises or within the same enterprise.

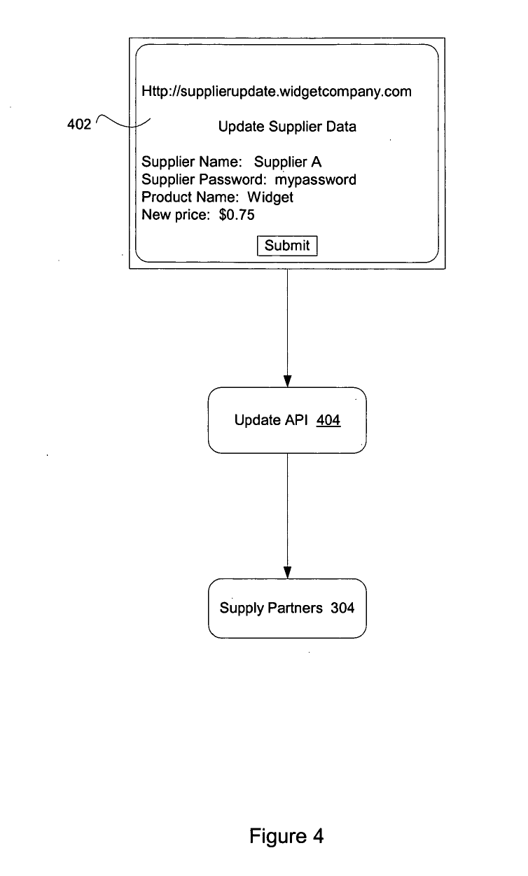

Aspects of the present invention allow business partners to update partner attributes without imposing a burden on the entity utilizing a business process. FIG. 4, for example, illustrates an embodiment in which a user interface 402 is used to update supply partner attributes in supply partner database 304. User interface 402 may be displayed on a computer that is connected to supply partners database 304 via a wide area network, such as the Internet. The captured information is transmitted via an application programming interface 404 to supply partners database 304. In the implementation shown, Supplier A changes the price charged for a widget without imposing any burden on the entity utilizing the business process.

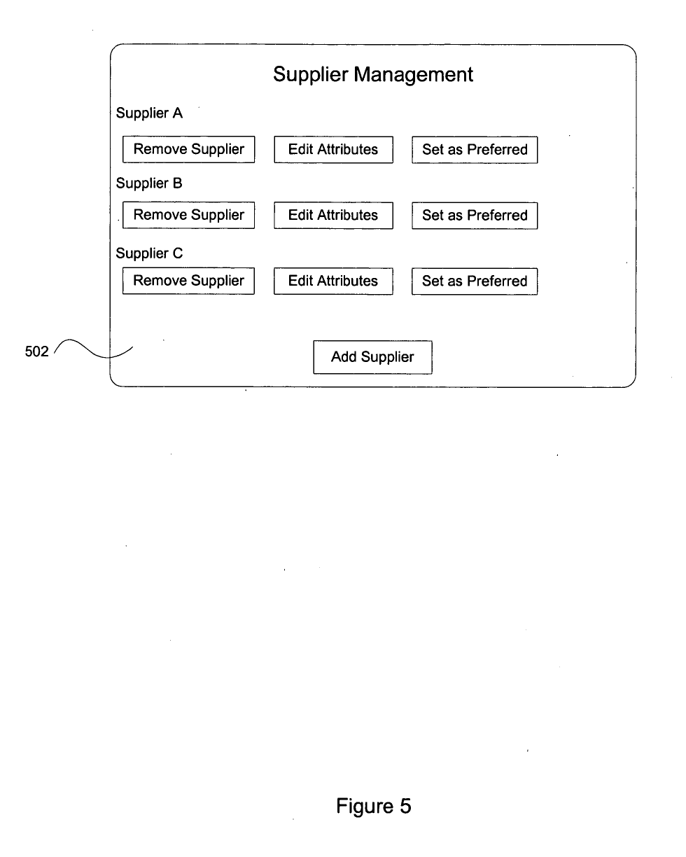

Of course, the entity utilizing a business process may also manage business partner data. FIG. 5 illustrates a user interface 502 that allows a user to remove suppliers, edit supplier attributes and identify a supplier as a preferred supplier.

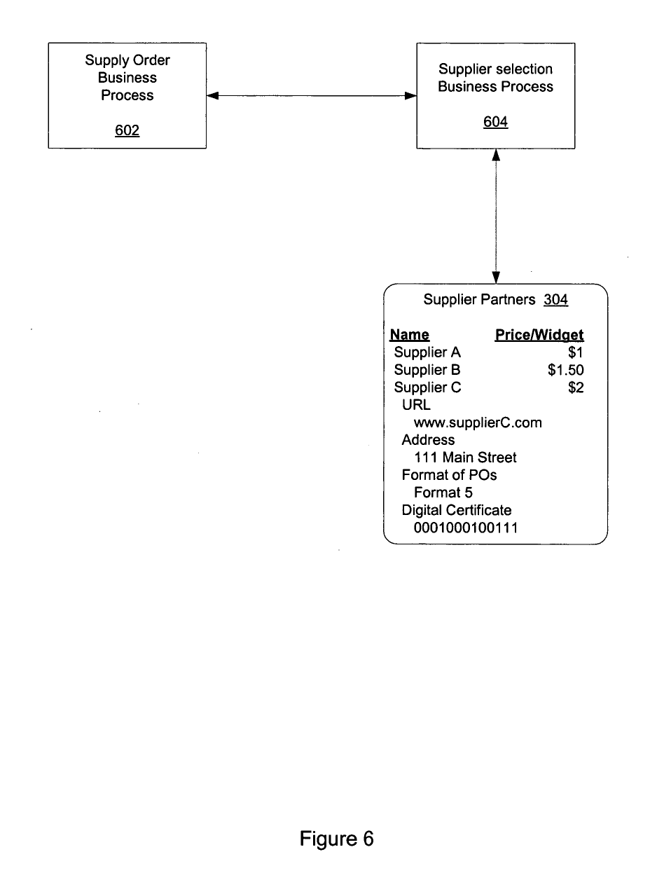

Aspects of the present invention may also use nested business processes. For example, FIG. 6 illustrates an embodiment in which a supply order business process 602 requests that a supplier selection business process 604 select a supply partner from supply partners database 304. Information identifying the selected partner may be transmitted back through supplier selection business process 604 to supply order business process 602.

The present invention has been described in terms of preferred and exemplary embodiments thereof. Numerous other embodiments, modifications and variations within the scope and spirit of the appended claims will occur to persons of ordinary skill in the art from a review of this disclosure. For example, the present invention allows for the modification of a business process without modifying business partner data.

1. A computer implemented method of performing a business process, the method comprising:
(a) running in a business process execution engine a compiled business process application that includes selection criteria for selecting partners; and
(b) utilizing the selection criteria to dynamically select a partner.

2. The method of claim 1, further including:
(c) receiving at least one attribute of the partner;.

3. The method of claim 2, wherein the at least one attribute comprises identifying information.

4. The method of claim 2, wherein the at least one attribute comprises selection information.

5. The method of claim 2, wherein the at least one attribute comprises a digital certificate.

6. The method of claim 2, wherein the at least one attribute comprises custom business partner data.

7. The method of claim 2, wherein the at least one attribute comprises an identification of a preferred document format.

8. The method of claim 7, wherein the document format comprises an extensible markup language schema.

9. The method of claim 2, further including:
(d) utilizing the at least one attribute of the partner while running the business process application.

10. The method of claim 1, further including:
(c) while running the business process application, binding instances of a business partner variable to the partner identified in (b).

11. A method of creating a computer implemented business process, the method comprising:
(a) defining a business process that includes criteria for selecting business partners;
(b) compiling the business process; and
(c) dynamically managing business partners without recompiling the business process.

12. The method of claim 11, wherein (c) comprises adding business partners.

13. The method of claim 11, wherein (c) comprises deleting business partners.

14. The method of claim 11, wherein (c) comprises modifying attributes of business partners.

15. The method of claim 11, wherein (c) is performed by at least one business partner.

16. The method of claim 15, wherein (c) comprises at least one business partner modifying at least one attribute of the at least one business partner.

17. The method of claim 16, wherein the at least one attribute comprises price information.

18. A computer readable medium containing computer-executable instructions for causing a computer device to perform a business process, the instructions comprise: executing the business process that includes selection criteria for selecting partners such that business partner data can be modified without modifying the business process.

19. A computer implemented system for performing a business process, the system comprising:
a computer readable medium containing a business process application that includes selection criteria for selecting business partners;
a computer readable medium containing a list of business partners and attributes of business partners; and
a business process execution engine that executes the business process application and selects business partners from the computer readable medium in accordance with the selection criteria.

20. The system of claim 19, wherein the attributes comprise contact information.

21. The system of claim 19, wherein the attributes comprise price information.

22. The system of claim 19, wherein the attributes comprise an identification of a preferred document format.

23. The system of claim 22, wherein the document format comprises an extensible markup language schema.
